(19) United States
(12) Patent Application Publication
(10) Pub. No.: US 2004/0112676 A1
(43) Pub. Date: Jun. 17, 2004

(54) Modular ladder including removable rungs

(76) Inventor: Timothy S. Skipper, Ormond Beach, FL (US)

Correspondence Address: John Wiley Horton, Pennington, Moore, Wilkinson, Bell & Dunbar, P.A., 2nd Floor, 215 S. Monroe St., Tallahassee, FL, 32301, US

(21) Appl. No.: 10/728,158

(22) Filed: Dec. 4, 2003

Related U.S. Application Data
(63) Continuation-in-part of application No. 10/162,022, filed on Jun. 4, 2002.
(60) Provisional application No. 60/430,532, filed on Dec. 4, 2002.

(51) Int. Cl. E06C 7/16

(52) U.S. Cl. 182/116

(57) ABSTRACT

A portable modular ladder which can be attached to a vertical object to be climbed—such as a tree. The ladder's structure is preferably provided by two or more vertical support columns locked together. These vertical support columns can be secured to the object to be climbed by a securing strap or other conventional means. A set of rungs extend outward from the vertical support columns. These rungs are optionally made removable, so that a user can remove the rungs and leave only the vertical support columns in place.

### CROSS-REFERENCES TO RELATED APPLICATIONS

This application is a non-provisional application claiming the benefit, pursuant to 37 C.F.R. § 1.53 (c), of an earlier filed provisional application. The provisional application listed the same inventor. The requisite information as to the provisional application is as follows:

application Ser. No. Filing Date

60/430,532 Dec. 4, 2002

This application is also a continuation-in-part of application Ser. No. 10/162,022, which was filed on Jun. 4, 2003, and which also listed the same inventor.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of ladders and tree stands. More specifically, the invention comprises a modular ladder and hunting tree stand.

2. Description of the Related Art

Modular ladders designed to allow the climbing of vertical objects such as trees are disclosed in several prior U.S. patents. Examples include U.S. Pat. No. 5,040,635 to Strickland (1991); U.S. Pat. No. 6,076,634 to Simon (2000); U.S. Pat. No. 6,170,609 to Dech (2001); and U.S. Pat. No. 6,340,071 to Dickemper (2002).

Likewise, tree stands allowing a hunter to remain in an elevated position are widely known. Examples include U.S. Pat. No. 5,097,925 to Walker, Jr. (1992); U.S. Pat. No. 5,862,883 to Carriere (1999); and U.S. Pat. No. 6,246,000 to Johnson (2001).

### BRIEF SUMMARY OF THE INVENTION

The present invention comprises a portable modular ladder which can be attached to a vertical object to be climbed—such as a tree. The ladder's structure is preferably provided by two or more vertical support columns locked together. These vertical support columns can be secured to the object to be climbed by a securing strap or other conventional means. A set of rungs extend outward from the vertical support columns. These rungs are optionally made removable, so that a user can remove the rungs and leave only the vertical support columns in place.

Several locking mechanisms are disclosed. These mechanisms prevent unauthorized use of the ladder by preventing the insertion of the rungs. A variety of configurations for the vertical support columns and the removable rungs are disclosed.

### BRIEF DESCRIPTION OF THE SEVERAL VIEWS OF THE DRAWINGS

FIG. 1 is an isometric view, showing a vertical support column.

FIG. 2 is a detail view of the object shown in FIG. 1

FIG. 3 is an isometric view, showing the addition of a securing strap.

FIG. 4 is a detail view, showing how the securing strap is attached

FIG. 5 is an isometric view, showing how the vertical support column attaches to a tree.

FIG. 6 is a detail view, showing the insertion of a removable rung into the vertical support column.

FIG. 7 is a detail view, showing the insertion of a removable rung into the vertical support column.

FIG. 8 is a detail view, showing the insertion of a removable rung into the vertical support column.

FIG. 9 is an isometric view, showing a stick assembly.

FIG. 10 is a perspective view, showing a completed ladder attached to a tree.

FIG. 11 is a perspective view, showing a completed ladder attached to a tree.

FIG. 12 is a detail view, showing a U-channel column.

FIG. 13 is an isometric view, showing the addition of an external lock to a vertical support column.

FIG. 14 is an isometric view, showing the addition of an external lock to a vertical support column.

FIG. 15 is an isometric view, showing the addition of an internal lock to a vertical support column.

FIG. 16 is an isometric view, showing the addition of an internal lock to a vertical support column.

FIG. 17 is an isometric view, showing the addition of an internal lock to a vertical support column.

FIG. 18 is an isometric view, showing an alternate embodiment for a removable rung.

FIG. 19 is an isometric view, showing the installation of the removable rung of FIG. 18.

FIG. 20 is an isometric view, showing another alternate embodiment for a removable rung.

FIG. 21 is an isometric view, showing the installation of the removable rung in FIG. 20.

FIG. 22 is an isometric view, showing another alternate embodiment for a removable rung.

FIG. 23 is an isometric view, showing the installation of the removable rung in FIG. 22.

FIG. 24 is an isometric view, showing the installation of still another alternate embodiment for a removable rung.

FIG. 25 is an isometric view, showing a split protrusion.

FIG. 26 is an isometric view, showing the installation of a split protrusion in a removable rung.

FIG. 27 is an isometric view, showing the installation of a removable rung having a split protrusion into a vertical support column.

FIG. 28 is an isometric view, showing the installation of a removable rung having a gusset.

FIG. 29 is an isometric view, showing a removable rung having a gusset.

### REFERENCE NUMERALS IN THE DRAWINGS

10 tree 12 tree stand

18 securing strap 20 standoff

26 inclined hole 30 strap lock

38 removable rung 40 step

42 insertion cylinder 60 transverse hole

96 vertical support column 100 extension

102 receptacle 104 admission slot

106 leading protrusion 108 trailing protrusion

110 first wall 112 second wall

116 locking handle 120 slot

24 notch 128 alternate rung

130 third wall 132 fourth wall

134 stick assembly 136 U-channel

138 external lock 140 lock hole

142 tab 144 hook

146 lock 148 stabilizing protrusion

158 alternate rung 152 alternate rung

154 rib 156 alternate rung

158 linear offset 160 split protrusion

162 spring housing 164 spring

166 pressure plate 168 shaft

170 hole 172 alternate rung

174 spring receiver 176 alternate rung

178 gusset 194 first prong

196 second prong 198 notch

206 internal lock 208 base standoff

### DESCRIPTION OF THE INVENTION

This invention pertains to improvements made in my prior designs for modular climbing ladders. These prior designs are disclosed in detail in copending U.S. application Ser. Nos. 10/058,9901 and 10/162,002, along with general descriptions of the operation of such devices. These prior copending applications are hereby incorporated by reference.

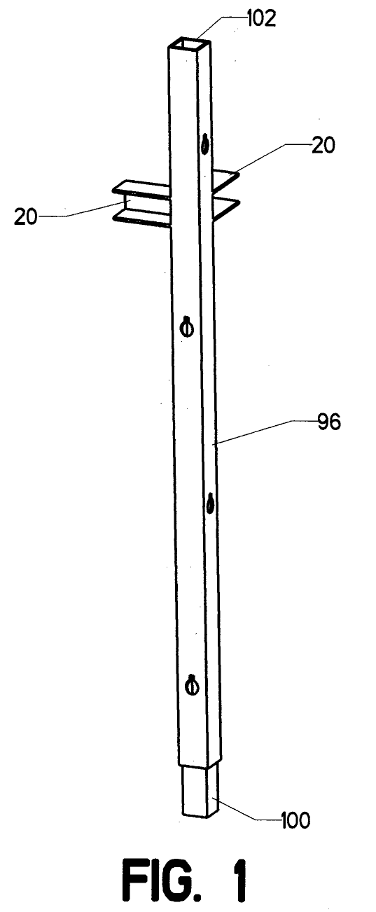

Modular climbing ladders are preferably portable. Thus, it is desirable to break the ladder into a series of shorter sections. FIG. 1 shows the primary structural element of the proposed modular ladder—designated as vertical support column 96. It is made from a length of hollow square stock. The open upper end forms receptacle 102. Extension 102 extends downward from the lower end. Extension 100 is designed to slide into a receptacle 102 on a second vertical support column 96 placed immediately below the one shown. Those skilled in the art will know that many equivalent interconnecting mechanisms could be used. As an example, a larger square sleeve could be substituted for extension 100. This larger sleeve would then slide over the exterior of the upper portion of a vertical support column 96 sitting below the one shown.

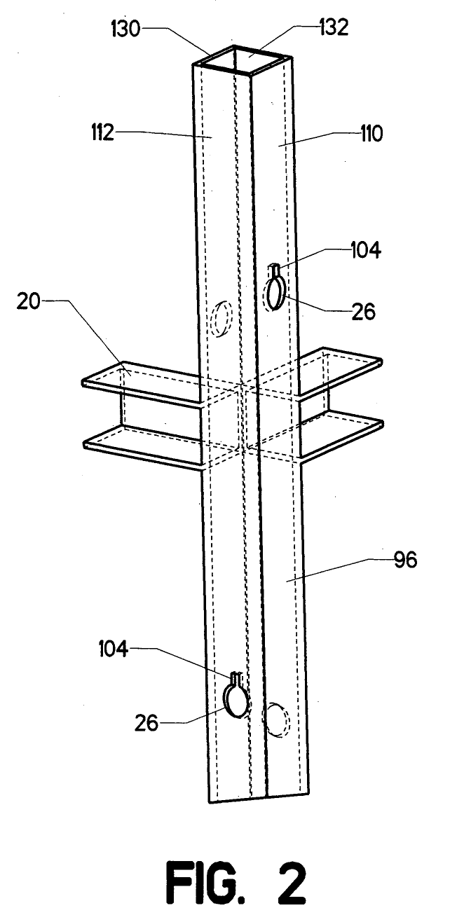

Standoffs 20 are provided to separate vertical support column 96 a short distance from the object to which it is attached. The column is designed to accept a set of removable rungs. Spaced holes are provided for this purpose. FIG. 2 shows the upper portion of the column in more detail. Being a piece of square hollow stock, the column is comprised of first wall 110, second wall 112, third wall 130, and fourth wall 132. A set of inclined holes 26 pierces first wall 110 and third wall 130. A second set of inclined holes 26 pierces second wall 112 and fourth wall 132.

The outward facing side of each inclined hole 26—meaning the side facing away from the standoffs—includes an admission slot 104. The reader will observe that the inclined holes are inclined from the horizontal. In other words, for the set piercing first wall 110 and third wall 130, the intersection of the hole with first wall 110 is higher than the intersection with third wall 130.

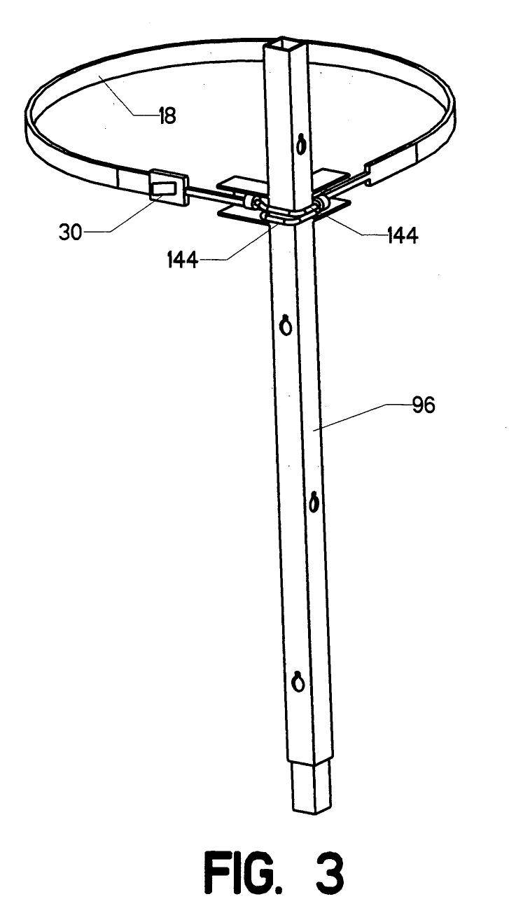

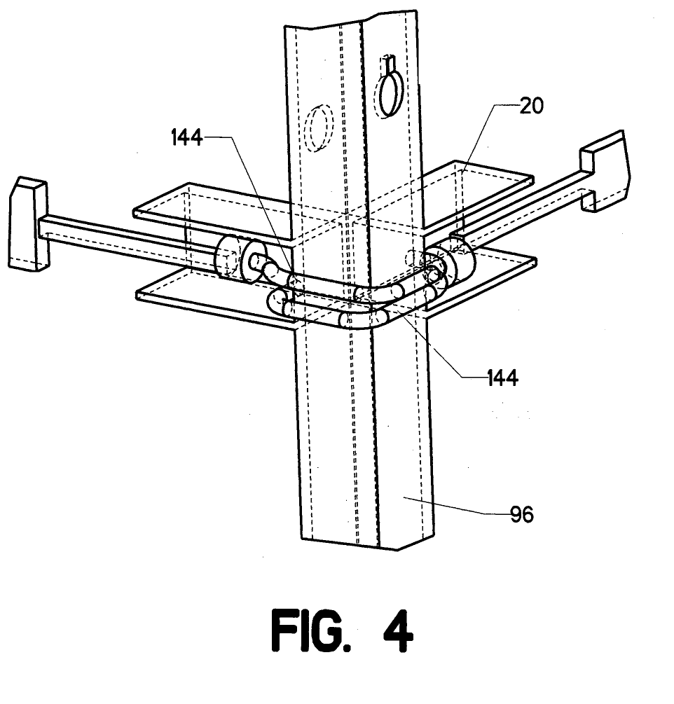

In use, each vertical support column must be attached to the object to be climbed (typically a tree). FIG. 3 shows the addition of securing strap 18 to the column. The two ends of the strap incorporate hooks 144. These are passed around the square section, preferably in the vicinity of the standoffs so that the standoffs will help hold the hooks in place. The overall length of the strap is adjusted by pulling it through strap lock 30. Strap lock 30 can then be cinched in order to maintain the desired length. FIG. 4 shows the attachment of the two hooks 144 in more detail. The two standoffs, preferably being made of “C-channel” tend to hold the hooks in position so that the strap does not slide up and down the column.

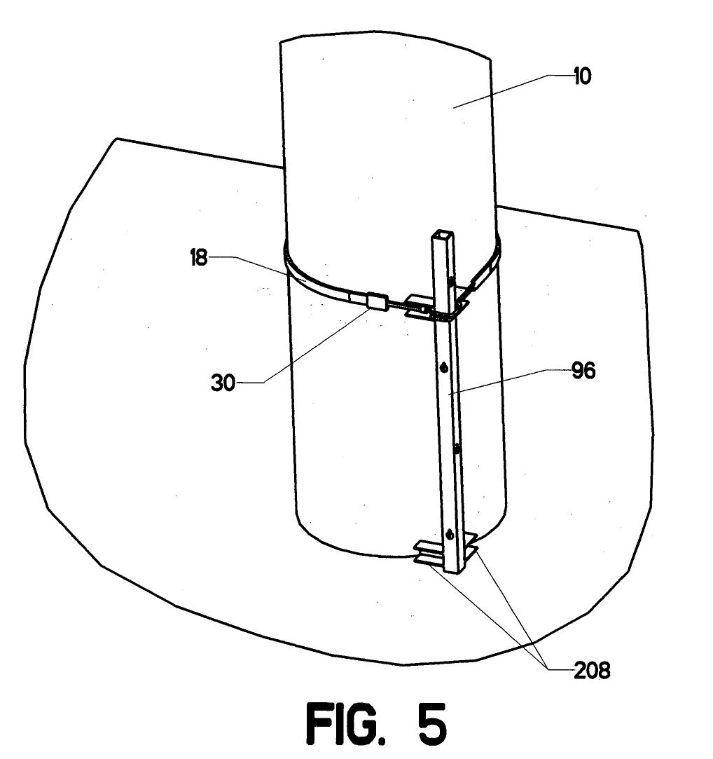

FIG. 5 shows vertical support column 96 attached to tree 10. Securing strap 18 has been passed around the tree, pulled tight, and locked into position by strap lock 30. For the vertical support column 96 which is to be placed on the ground, it is advantageous to provide a second set of standoffs. These are designated as base standoffs 208 in the view. They distribute load to the ground to prevent the column from sinking in. They also tend to properly orient the column with respect to the tree. The reader will observe how the standoffs prevent the column from being pulled directly against the tree. Those skilled in the art will also realize that the “Vee” shape of the two standoffs will rotationally stabilize the column with respect to the tree.

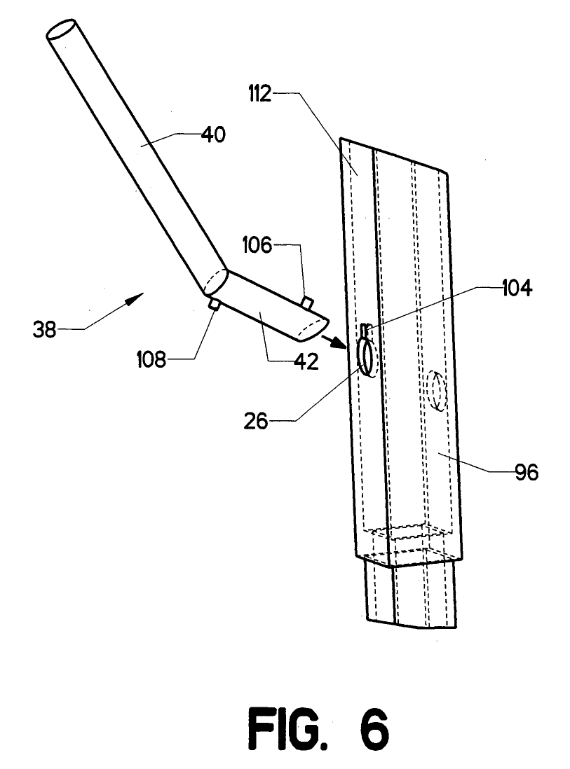

Rungs must be attached to each vertical support column in order to facilitate climbing. The rungs are preferably made removable so that a user can prevent unauthorized climbing. FIGS. 6-8 show the process of installing a typical removable rung. Removable rung 38 includes insertion cylinder 42, and an angularly offset step 40. Leading protrusion 106 extends outward from insertion cylinder 42 in a position distal to the step. Trailing protrusion 108 extends outward in a position adjacent to the step. It is angularly displaced from leading protrusion 106 by 180 degrees.

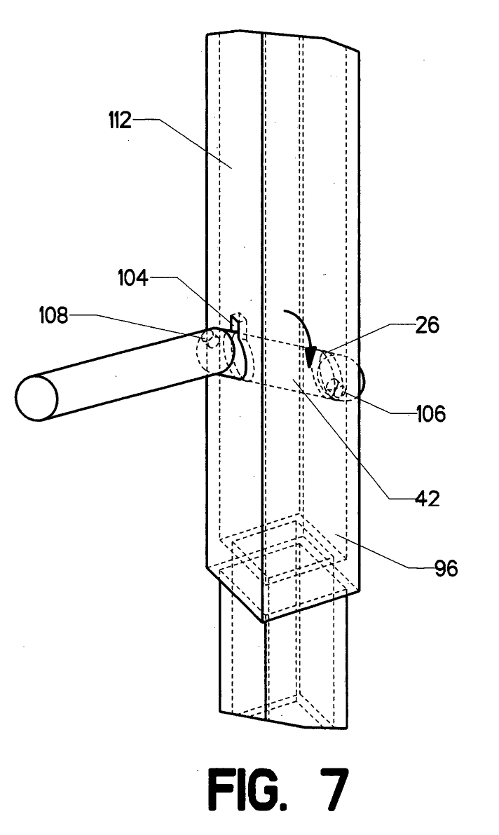

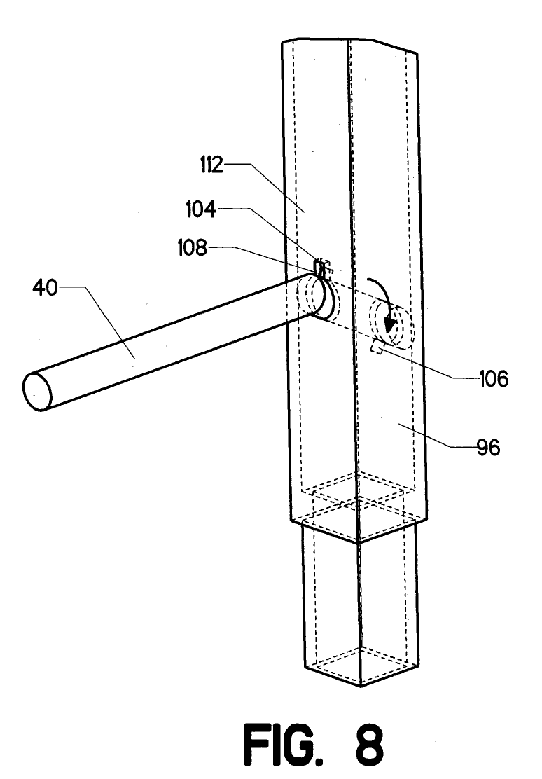

To start the insertion process, the user inverts the run in order to align leading protrusion 106 with admission slot 104 (as shown in FIG. 6). The user then pushes insertion cylinder 42 into inclined hole 96. The user continues advancing the insertion cylinder into the hole until leading protrusion 106 comes up against the inner surface of the far wall. The user then begins rotating the rung in order to align trailing protrusion 108 with admission slot 104. FIG. 7 shows the rung after it has been rotated through 90 degrees of the 180 degrees needed. FIG. 8 shows the rung after it has been rotated 180 degrees. At this point, the user pushes the rung inward, allowing trailing protrusion 108 to come to rest within admission slot 104. The leading and trailing protrusions are spaced apart a distance which ensures that when leading protrusion 106 is hard against the inner surface of the far wall, trailing protrusion 108 lies within admission slot 104.

Those skilled in the art will therefore realize that the rung is prohibited from rotating. The position shown in FIG. 8 is very stable. The user places his or her foot on step 40 to climb. This weight tends to force insertion cylinder 42 further into inclined hole 26. Thus, leading protrusion 106 is pressed firmly against the inner surface of the far wall. This fact also ensures that trailing protrusion 108 is held firmly within admission slot 104. The reader will appreciate that each wall of the column has thickness—typically 0.090 to 0.150 inches. The side walls of the admission slot bound the movements of the trailing protrusion.

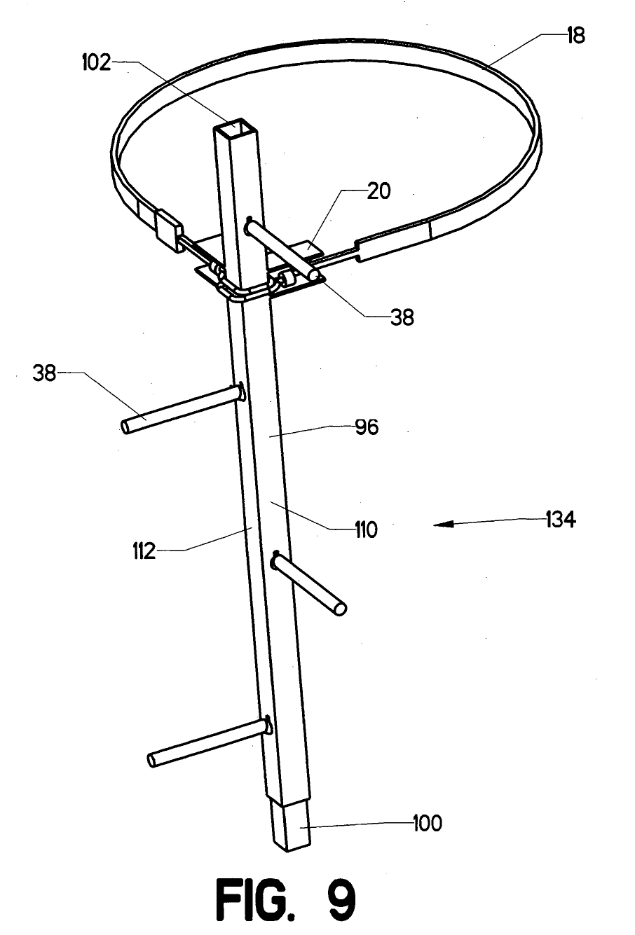

FIG. 9 shows vertical support column 96 with securing strap 18 in place and a set of removable rungs 38 installed (collectively designated as stick assembly 134). The reader will observe how the inclined holes alternate between the first and second walls, resulting in the rungs being displaced 90 degrees in the installed position. This rung spacing is preferable, since it allows the column to be placed close to the tree—thereby enhancing stability—while still allowing clearance for the forward portion of the user's foot when he or she is standing on a rung. The 90 degree rung separation also permits the use of smaller standoffs, which makes for a more compact overall design, as well as obvious material savings.

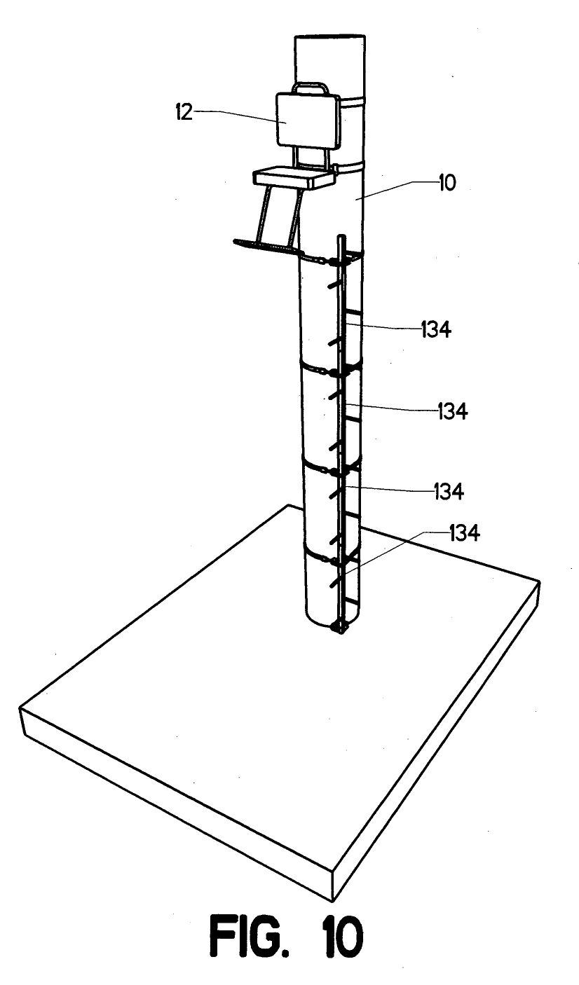

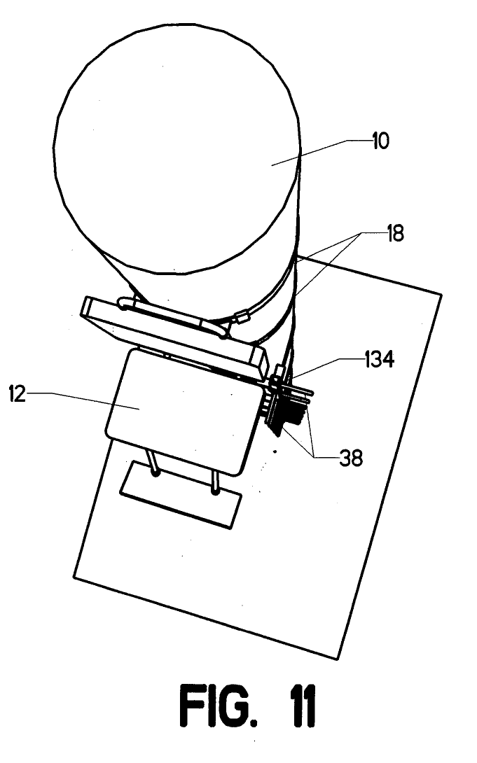

FIG. 10 shows four complete stick assemblies 134 attached to a tree. The lowest vertical support column is equipped with a second set of standoffs near its base (as shown in FIG. 5). The stick assemblies 134 are in place to provide access to a prior art tree stand 12, which is independently attached to the tree. FIG. 11 shows the same assembly from a different perspective. The reader will observe how the removable rungs 38 are well clear of the tree, even with the use of the relatively small standoffs 20. The rung orientation also allows the user to more easily step off the ladder and onto the tree stand.

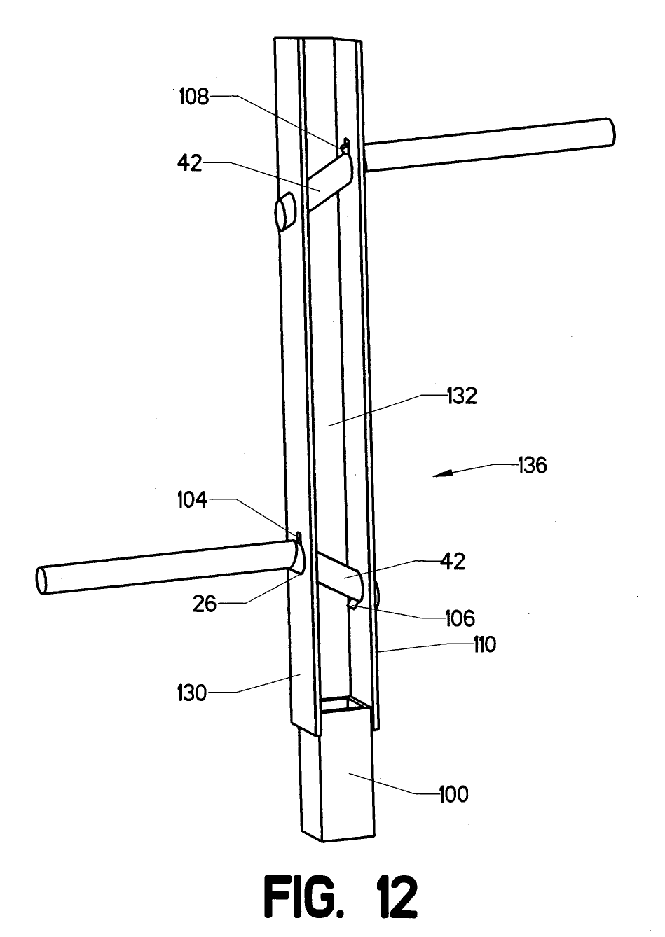

Those skilled in the art will realize that the rung sets can also be spaced 180 degrees apart (although larger standoffs will likely be needed). FIG. 12 shows a different type of column, designated as U-channel column 136. It only has three walls. It does not need a fourth wall since only two walls are pierced by the inclined holes. The insertion and action of the removable rungs is the same as was described for FIGS. 6-8.

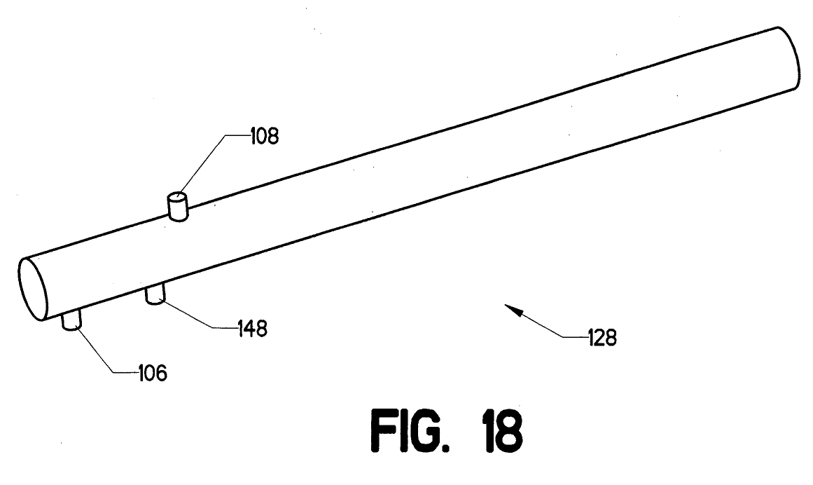

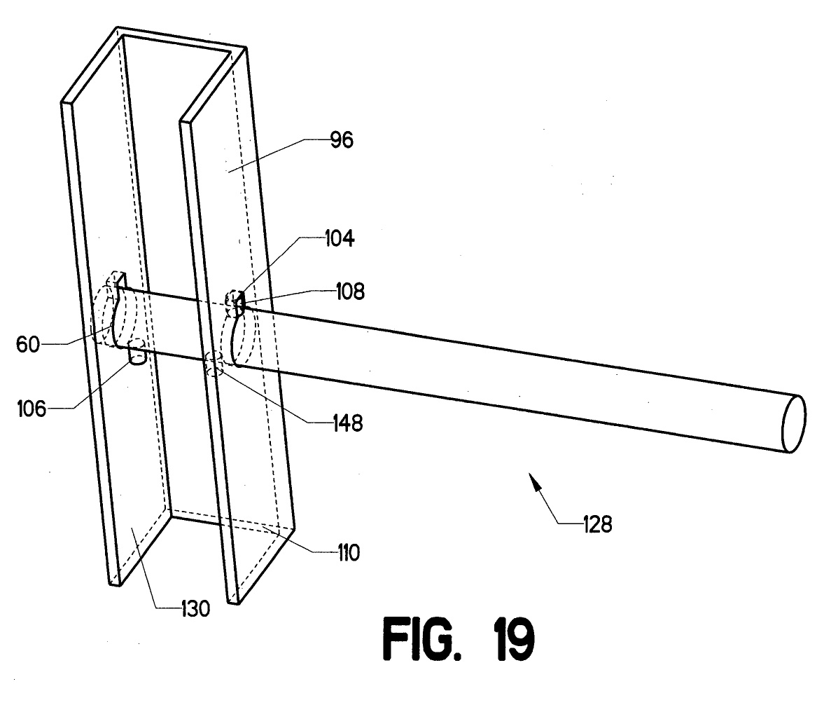

Other variations in the rung and column design are possible. FIG. 18 depicts alternate rung 128, which uses a step which is aligned with the insertion cylinder (It lacks the angular offset). Such a step is designed for a hole which is not inclined. Thus, additional features are needed to secure the step in place. Stabilizing protrusion 148 is added between leading protrusion 106 and trailing protrusion 108. FIG. 19 shows alternate rung 128 in the installed position. To install it, the user first aligns leading protrusion 106 with admission slot 104 and advances the rung into transverse hole 60. The user continues advancing the rung inward until stabilizing protrusion 148 clears admission slot 104. The user then rotates the rung 180 degrees to align trailing protrusion 108 with admission slot 104. The reader will observe that a portion of the insertion cylinder sticks out beyond the far wall (third wall 130). If the rung is pulled outward accidentally, stabilizing protrusion 148 will bear against the inner surface of first wall 110 before the insertion cylinder slips out of the far wall. Thus, the rung will not become accidentally dislodged.

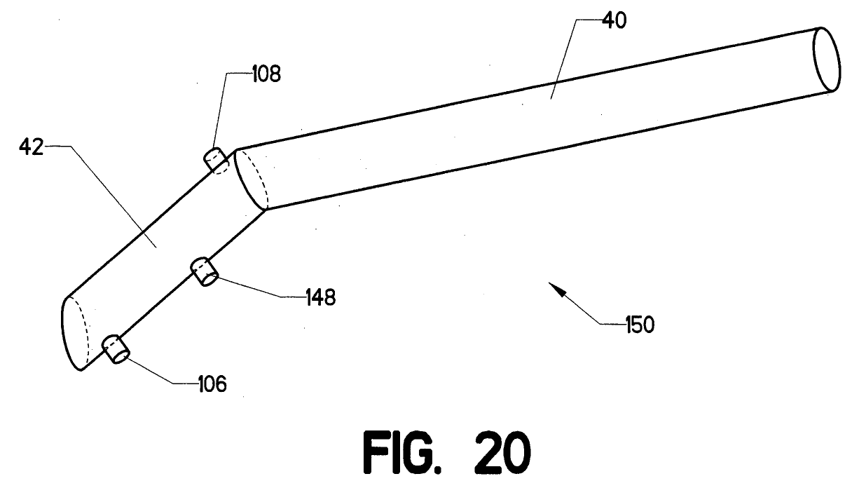

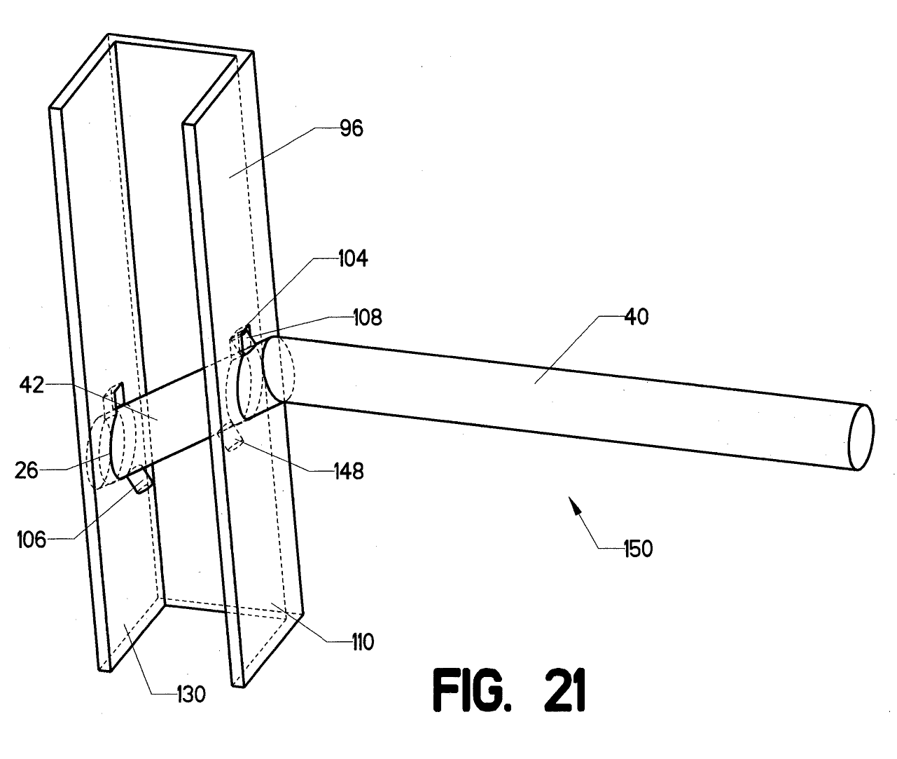

FIG. 20 shows the same addition applied to a rung with an angularly offset step 40 (designated as alternate rung 150). FIG. 21 shows alternate rung 150 installed. Stabilizing protrusion 148 prevents insertion cylinder 42 being accidentally pulled outward. The only way to remove the rung is to pull the insertion cylinder out enough to pull the trailing protrusion out of the admission slot, then manually rotate the rung in order to align stabilizing protrusion 148 with admission slot 104.

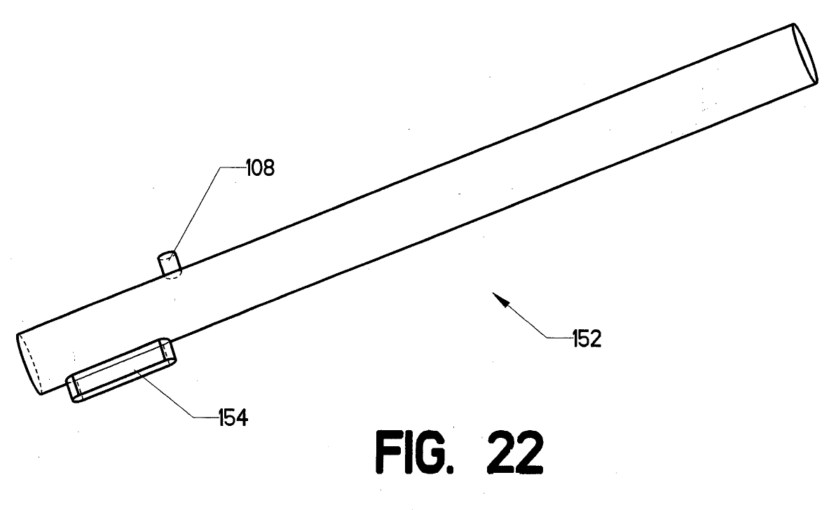

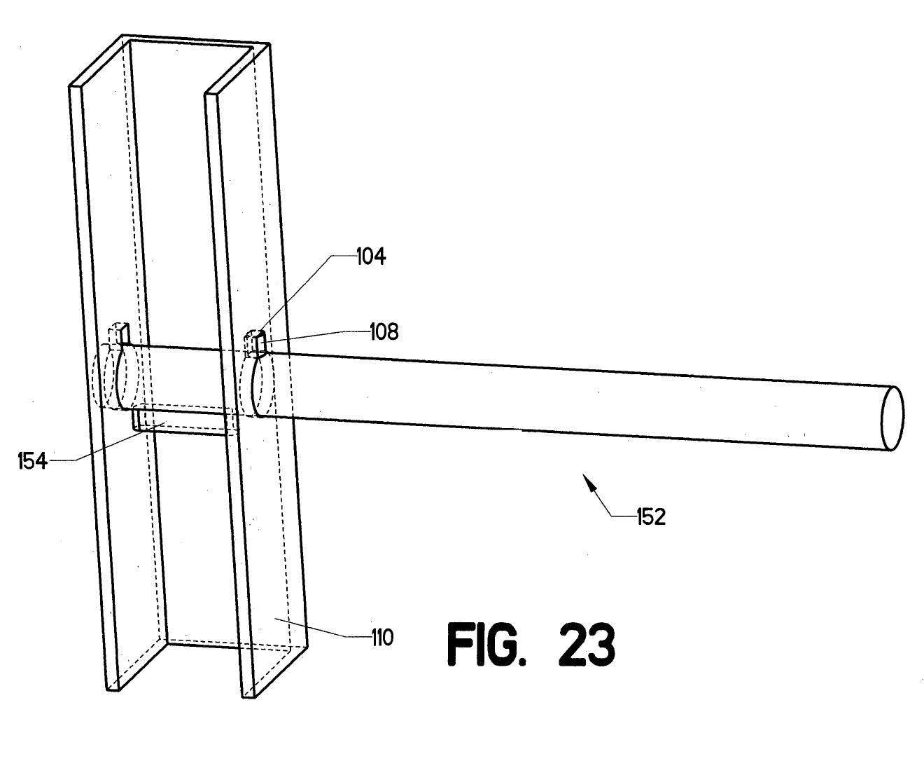

Of course, the function carried out by leading protrusion 106 and stabilizing protrusion 148 can be performed using different geometry. FIG. 22 shows alternate rung 152, which substitutes rib 154 for leading protrusion 106 and stabilizing protrusion 148. FIG. 23 shows this embodiment installed. Those skilled in the art will realize that the rib performs the same function, having essentially just filled in the gap between the leading and stabilizing protrusions (the gap serving no real purpose). The rib may actually be a bit easier to slide through the admission slot than the two separate protrusions.

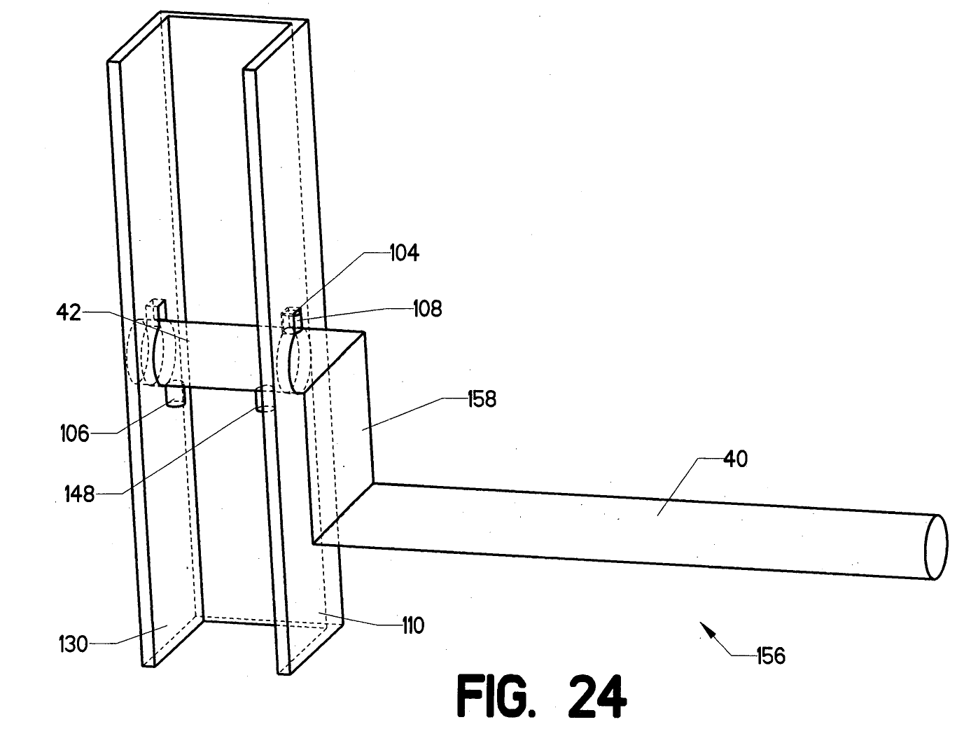

FIG. 24 shows alternate rung 156, in which step 40 is linearly offset from insertion cylinder 42 by the addition of linear offset 158. This linear offset tends to keep the rung in the orientation shown, since the user's weight on the step will naturally rotate the step to its lowest position relative to the insertion cylinder. A stabilizing protrusion 148 (or equivalent rib) may also be added to inhibit unintentional dislodgement of the rung.

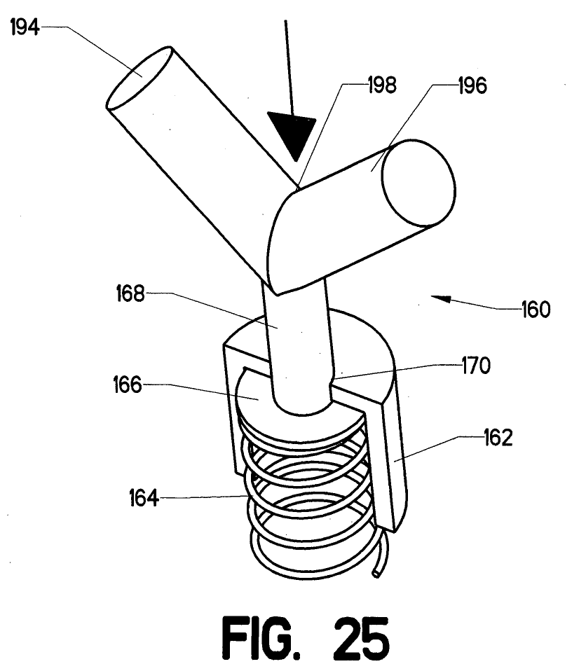

More complex devices for securing the rung in its installed position are also possible. A spring-loaded protrusion can be substituted for trailing protrusion 108. FIG. 25 shows split protrusion 160. Spring housing 162 (the front half of which is shown cut away for visual clarity) houses a spring 164, which bears upward against movable pressure plate 166. Shaft 168 extends upward through hole 170 in spring housing 162. First prong 194 and second prong 196 are attached to shaft 168, joining to form notch 198.

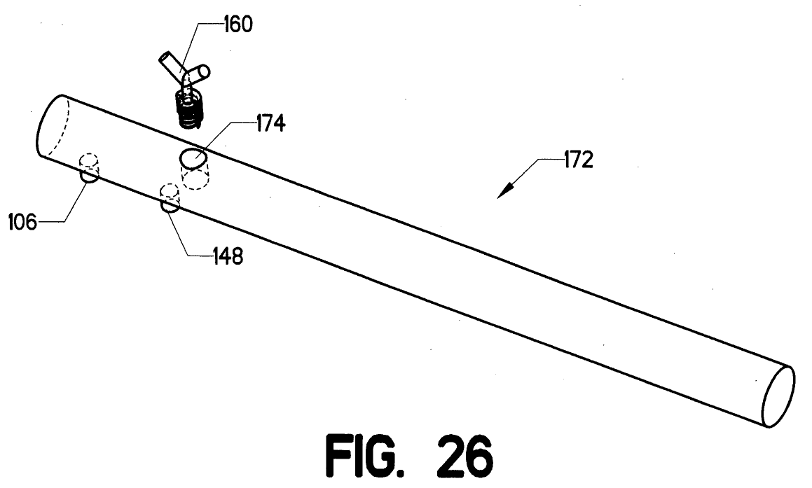

FIG. 26 shows the installation of split protrusion 160 in spring receiver 174 (simply a blind hole) of alternate rung 172. Spring housing 162 is press fitted, threaded, glued, or otherwise secured in spring receiver 174. The spring then urges shaft 168 upward. Although, if one presses on notch 198, one is able to press it downward against the spring force.

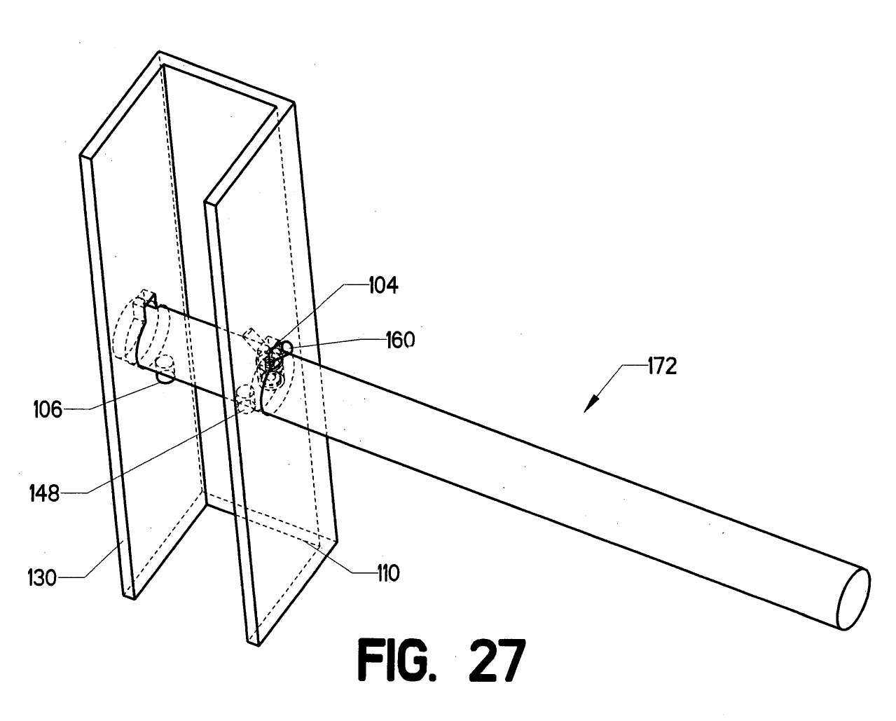

FIG. 27 shows the installation of alternate rung 172. The user must first align leading protrusion 106 with admission slot 104, then advance the insertion cylinder through the hole. The user then rotates the rung 180 degrees and aligns split protrusion 160 with admission slot 104. The user must then depress the movable parts of the split protrusion so that first prong 194 passes into the interior of the column. The user then releases the movable parts. The spring then snaps notch 198 up against the top of the admission slot (as shown in FIG. 27). In this position, the rung will not rotate or back out. In order to remove the rung, the user must again depress the moving portions of split protrusion 160 and pull the rung free.

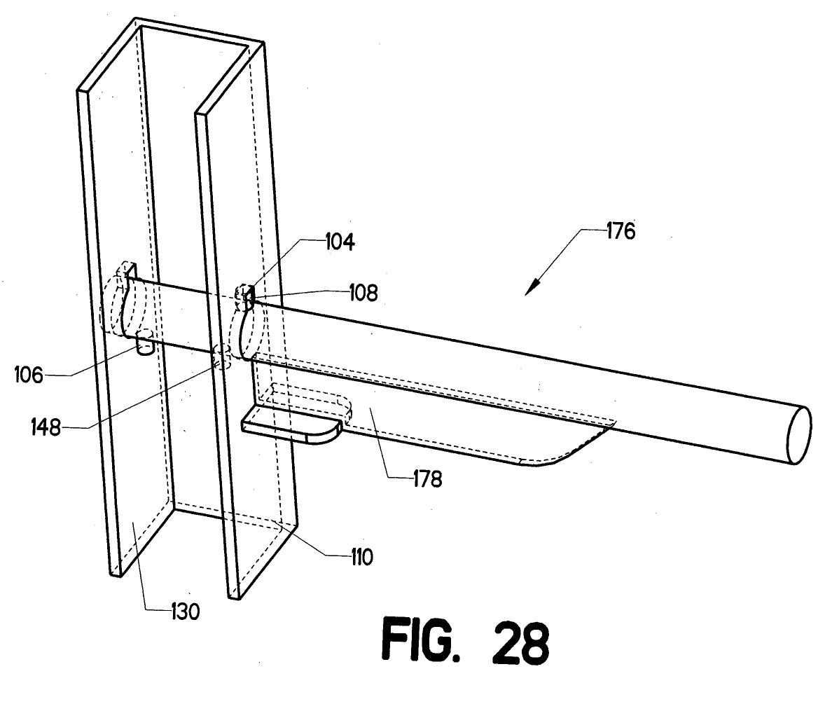

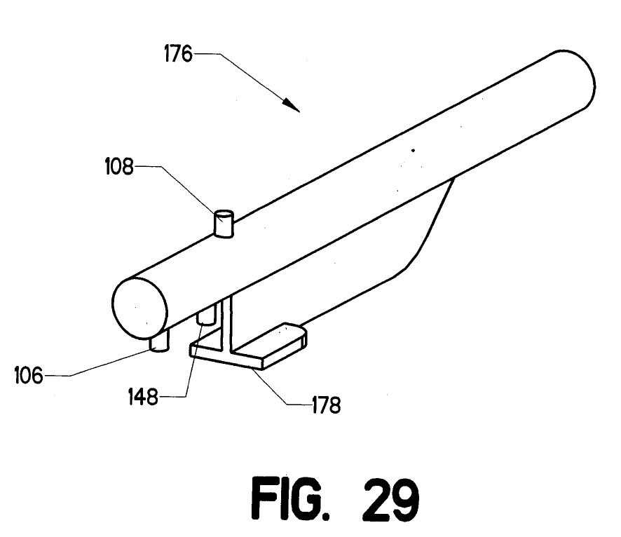

FIG. 28 shows yet another alternate embodiment, designated as alternate rung 176. This rung features a gusset 178, which is positioned to bear against the outside of first wall 110 when the rung is stepped on. FIG. 29 shows gusset 178 from another angle. The other rungs shown transmit load to the vertical support column through the interaction between the insertion cylinder and the holes in the column's walls. Alternate rung 176 also transmits a load via having the portion of gusset 178 facing the viewer in FIG. 29 bear against the outside of first wall 110. One or more additional protrusions may also be used.

The reader will note that many of the examples have shown a vertical support column having only three walls (a “C-Channel” or “U-Channel”). Many of the embodiments shown will work for three walls as well as four. Some, in fact need only two walls, although the desire for column strength makes at least three walls preferable.

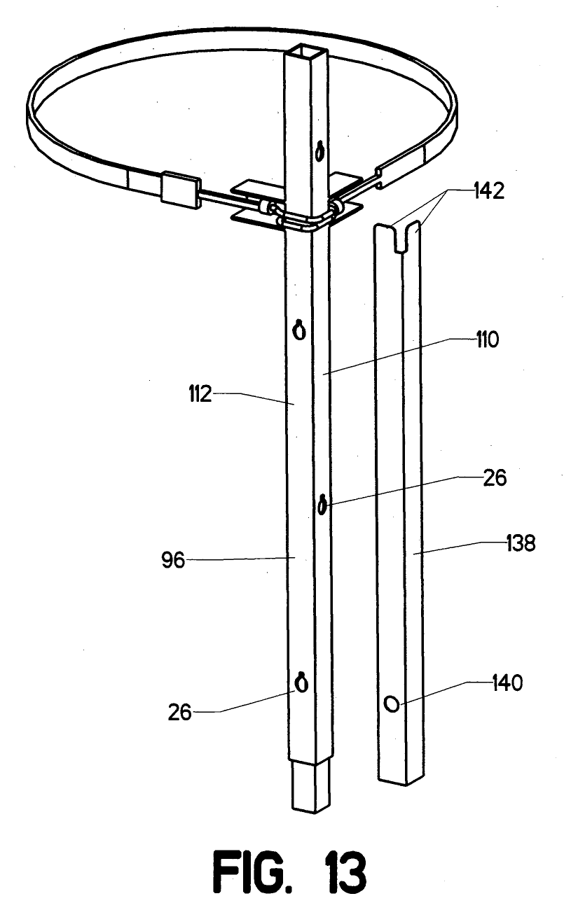

In some applications it is desirable to leave the ladder in place. Yet, the user may wish to prevent unauthorized climbing by other people. One way to accomplish this is by removing the rungs. However, other persons may be in possession of the rungs. Thus, an additional security measure is desired. FIG. 13 shows external lock 138 next to vertical support column 96. External lock 138 is configured to cover first wall 110 and second wall 112. It has lock hole 140 near its lower end, and two tabs 142 extending upward from its upper end (The use of only one tab is also possible).

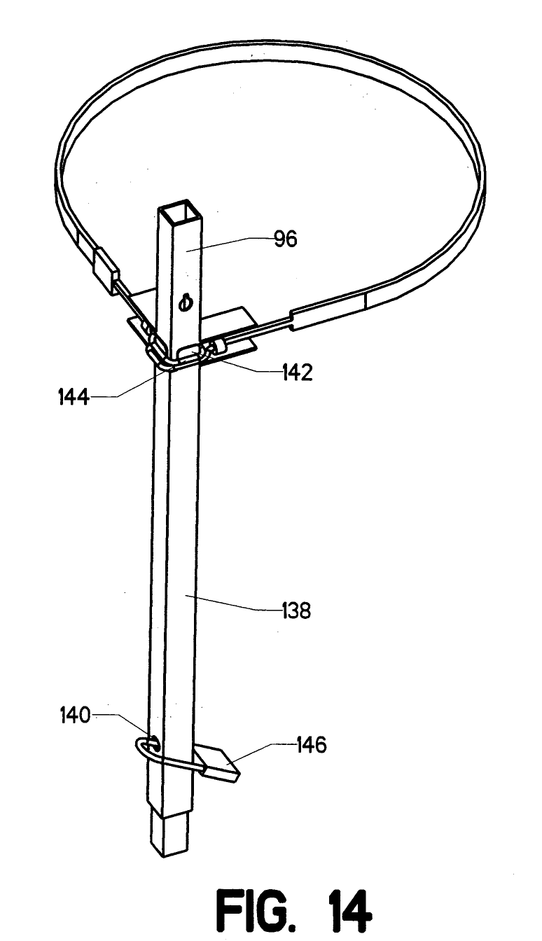

FIG. 14 shows external lock 138 in position covering vertical support column 96. The two tabs 142 have been slipped under the hooks 144. Lock hole 140 has been aligned with the lowest inclined hole 26. Lock 146 has been passed through this hole, thereby securing external lock 138. Thus, removable rungs cannot be installed. It may only be necessary to lock out the lowest vertical support column in order to effectively secure the ladder.

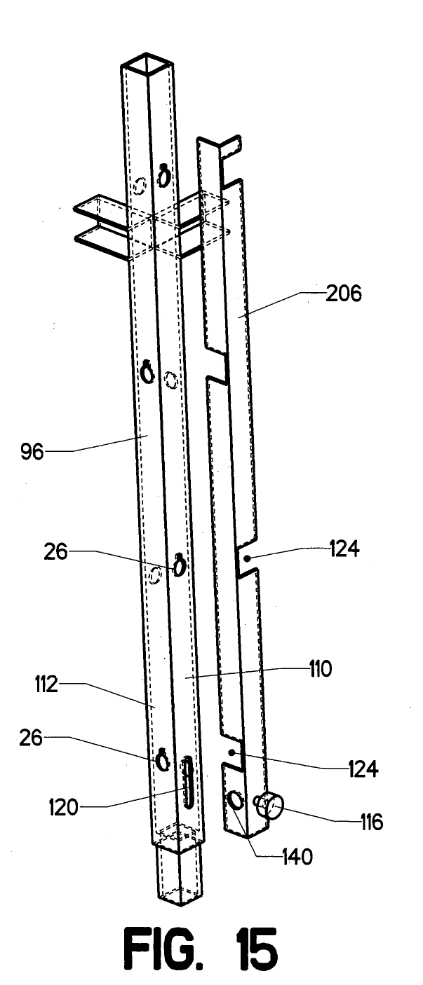

FIG. 15 shows a second type of locking device, intended to operate within the hollow interior of the vertical support column. Internal lock 206 comprises two walls forming a ninety degree angle. These are sized to slidably fit within the square interior of vertical support column 96. Slot 120 is added to allow locking handle 116 to be accessed from outside. Internal lock 206 includes a series of notches 124. These align with inclined holes 26 when internal lock 206 is in the unlocked position (In this position, locking handle 116 rests in the bottom of slot 120). In the unlocked position, internal lock 206 does not interfere with the insertion of the removable rungs. Lock hole 140 is provided to secure the lock in the locked position.

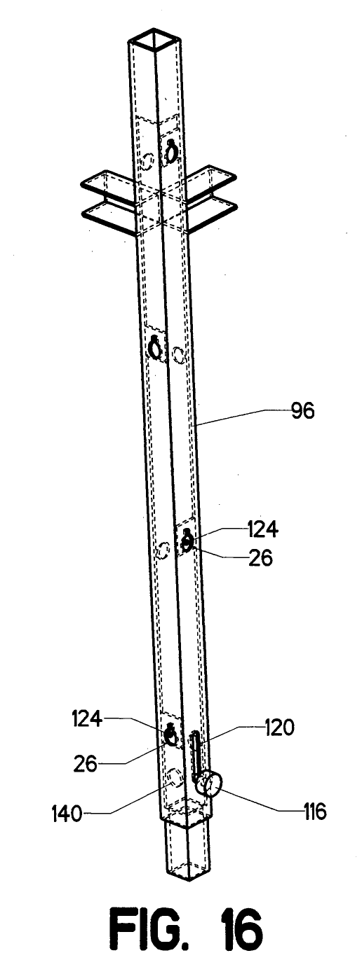

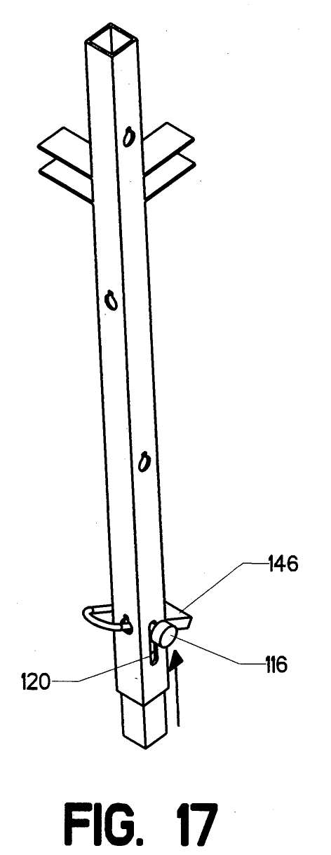

FIG. 16 shows internal lock 206 installed and in the unlocked position. As stated previously, notches 124 allow the insertion of the removable rungs. In order to lock the device, locking handle 116 is grasped and pulled upward to the top of slot 120. FIG. 17 shows this position. Lock hole 140 then aligns with the lowest inclined hole 26, allowing a user to insert lock 146 through the hole, thereby locking internal lock 206 in the locked position. All the inclined holes are blocked by the internal lock when in this position.

Although the preceding description contains significant detail, it should not be construed as limiting the scope of the invention but rather as providing illustrations of the preferred embodiment of the invention. Thus, the scope of the invention should be fixed by the following claims, rather than by the examples given.

Having described my invention, I claim:

1. A ladder having removable rungs, comprising:
a. a vertical support column having a first wall, a second wall, a third wall and a fourth wall;
b. a first hole passing completely through said first wall and said third wall;
c. a second hole passing completely through said second wall and said fourth wall;
d. a first removable rung, including an insertion cylinder sized to slidably fit within said first hole, a step, and a leading protrusion extending outward from said insertion cylinder distal from said step;
e. a second removable rung, including an insertion cylinder sized to slidably fit within said second hole, a step, and a leading protrusion extending outward from said insertion cylinder distal from said step;
f. wherein said first wall of said vertical support column opens into a first admission slot proximate said first hole, sized to allow said leading protrusion on said first removable rung to slide therethrough, so that said first removable rung can be inserted into said vertical support column by placing said insertion cylinder within said first hole, sliding said leading protrusion through said first admission slot, and advancing said insertion cylinder into said first hole so that said leading protrusion eventually rests between said first wall and said third wall; and
g. wherein said second wall of said vertical support column opens into a second admission slot proximate said second hole, sized to allow said leading protrusion on said second removable rung to slide therethrough, so that said second removable rung can be inserted into said vertical support column by placing said insertion cylinder within said second hole, sliding said leading protrusion through said second admission slot, and advancing said insertion cylinder into said second hole so that said leading protrusion eventually rests between said second wall and said fourth wall.

2. A ladder as recited in claim 1, further comprising locking means moveable between an unlocked position wherein said removable rungs can be inserted in said column, and a locked position wherein said removable rungs cannot be inserted in said column.

3. A ladder as recited in claim 2, wherein said locking means comprises:
a. a locking slide, slidably disposed with respect to said vertical support column, and having an unlocked position where said removable rungs can be inserted in said column, and a locked position where said removable rungs cannot be inserted in said column;
b. wherein said locking slide has a first notch, positioned to align with said first hole when said locking slide is in said unlocked position, and positioned to obstruct said first hole when said locking slide is in said locked position;
c. wherein said locking slide has a second notch, positioned to align with said second hole when said locking slide is in said unlocked position, and positioned to obstruct said second hole when said locking slide is in said locked position; and
d. means for locking said locking slide in said locked position.

4. A ladder as recited in claim 1, wherein:
a. said first hole has an intersection with said first wall and an intersection with said third wall, and wherein said intersection with said first wall is higher than said intersection with said third wall so that said first hole is inclined from the horizontal; and
b. said second hole has an intersection with said second wall and an intersection with said fourth wall, and wherein said intersection with said first second is higher than said intersection with said fourth wall so that said second hole is inclined from the horizontal.

5. A ladder having a removable rung, comprising:
a. a vertical support column having a first wall and a second wall;
b. a hole passing completely through said first wall and said second wall;
c. a removable rung, including an insertion cylinder sized to slidably fit within said hole, a step, and a leading protrusion extending outward from said insertion cylinder distal from said step;
d. wherein said first wall of said vertical support column opens into an admission slot proximate said hole, sized to allow said leading protrusion on said removable rung to slide therethrough, so that said
e. wherein said removable rung includes a trailing protrusion, extending from said insertion cylinder in a position proximate said step;
f. wherein said removable rung includes a stabilizing protrusion, extending from said insertion cylinder in a position between said leading protrusion and said trailing protrusion;
g. wherein said trailing protrusion is angularly offset from said leading protrusion; and
h. wherein said stabilizing protrusion is angularly aligned with said leading protrusion, so that said removable rung can be inserted into said vertical support column by placing said insertion cylinder within said hole, sliding said leading protrusion and said stabilizing protrusion completely through said admission slot, rotating said insertion cylinder in order to align said trailing protrusion with said admission slot, and advancing said insertion cylinder into said hole so that said trailing protrusion rests within said admission slot, and said leading protrusion and said stabilizing protrusion rest between said first wall and said second wall.

6. A ladder as recited in claim 5, wherein said step is angularly offset from said insertion cylinder.

7. A ladder as recited in claim 5, wherein said step is linearly offset from said insertion cylinder.

8. A ladder as recited in claim 1, further comprising means for securing said ladder to an object to be climbed.

9. A ladder as recited in claim 2, further comprising means for securing said ladder to an object to be climbed.

10. A ladder as recited in claim 3, further comprising means for securing said ladder to an object to be climbed.

11. A ladder as recited in claim 4, further comprising means for securing said ladder to an object to be climbed.

12. A ladder as recited in claim 5, further comprising means for securing said ladder to an object to be climbed.

13. A ladder as recited in claim 6, further comprising means for securing said ladder to an object to be climbed.

14. A ladder as recited in claim 7, further comprising means for securing said ladder to an object to be climbed.

15. A ladder having a removable rung, comprising:
a. a vertical support column having a first wall and a second wall;
b. a hole passing completely through said first wall and said second wall;
c. a removable rung, including an insertion cylinder sized to slidably fit within said hole, a step, and an elongated rib extending outward from said insertion cylinder distal from said step;
d. wherein said first wall of said vertical support column opens into an admission slot proximate said hole, sized to allow said elongated rib on said removable rung to slide therethrough, so that said
e. wherein said removable rung includes a trailing protrusion, extending from said insertion cylinder in a position proximate said step;
f. wherein said trailing protrusion is angularly offset from said elongated rib, so that said removable rung can be inserted into said vertical support column by placing said insertion cylinder within said hole, sliding said elongated rib completely through said admission slot, rotating said insertion cylinder in order to align said trailing protrusion with said admission slot, and advancing said insertion cylinder into said hole so that said trailing protrusion rests within said admission slot, and said elongated rib rests between said first wall and said second wall.

16. A ladder as recited in claim 5, further comprising a gusset, extending outward from said step, and positioned to bear against said first wall when said removable rung is installed in said hole.

17. A ladder having a removable rung, comprising:
a. a vertical support column having a first wall and a second wall;
b. a hole passing completely through said first wall and said second wall;
c. a removable rung, including an insertion cylinder sized to slidably fit within said hole, a step, and a leading protrusion extending outward from said insertion cylinder distal from said step;
d. wherein said first wall of said vertical support column opens into an admission slot proximate said hole, sized to allow said leading protrusion on said removable rung to slide therethrough, so that said
e. wherein said removable rung has a split protrusion located proximate said step, wherein said split protrusion includes
I. a first prong proximate said leading protrusion;
ii. a second prong distal to said leading protrusion;
iii. wherein said first and second prongs join to form a notch; and
iv. biasing means for urging said notch away from said insertion cylinder.

18. A ladder as recited in claim 17, wherein said split protrusion is angularly displaced from said leading protrusion.

19. A ladder as recited in claim 17, wherein said removable rung further comprises a stabilizing protrusion.
